(19) United States
(12) Patent Application Publication
(10) Pub. No.: US 2025/0378564 A1
(43) Pub. Date: Dec. 11, 2025

(54) SEMANTIC SEGMENTATION-BASED EXCLUSION FOR LOCALIZATION

(71) Applicant: Apple Inc., Cupertino, CA (US)

(72) Inventors: Huiwen Guo, Newark, CA (US); Jose Maria Facil Ledesma, San Francisco, CA (US); Lina M. Paz-Perez, Santa Clara, CA (US); Oleg Naroditsky, San Francisco, CA (US); Abdelhamid Dine, Santa Clara, CA (US); Joseph A. Menke, Sunnyvale, CA (US)

(21) Appl. No.: 19/220,771

(22) Filed: May 28, 2025

Related U.S. Application Data
(60) Provisional application No. 63/657,615, filed on Jun. 7, 2024.

(51) Int. Cl. G06T 7/246; G06T 7/73; G06V 10/764; G06V 10/771; G06V 20/20; G06V 20/40; G06V 20/70

(52) U.S. Cl. CPC G06T 7/248; G06T 7/74; G06V 10/764; G06V 10/771; G06V 20/20; G06V 20/46; G06V 20/70; G06T 2207/30244; G06T 2207/30252

(57) ABSTRACT

Various implementations disclosed herein include devices, systems, and methods that localize (e.g., determine a pose) of a device in a 3D environment based on sensor data and semantic segmentation information. Some implementations provide device localization on moving platforms (e.g., trains, buses, cars, etc.) based on camera images (i.e., vision). Since motion (i.e., IMU) data may not be reliable in such moving environments, image and/or other sensor data may be more heavily relied upon than in other circumstances. Some implementations improve the usability of vision-based tracking features points. This may involve identifying and removing outlier tracking feature points based on semantics. For example, tracking features points corresponding to the outside environment, which is not moving with the moving platform, may be excluded based on semantic information identifying that they are not part of the moving platform (e.g., that they are instead seen through a window, not trackable, etc.).

### CROSS-REFERENCE TO RELATED APPLICATIONS

This application claims the benefit of U.S. Provisional Application Ser. No. 63/657,615 filed Jun. 7, 2024, which is incorporated herein in its entirety.

### TECHNICAL FIELD

The present disclosure generally relates to systems, methods, and electronic devices for localizing a device in a three-dimensional (3D) coordinate system based on sensor data and semantic segmentation information.

### BACKGROUND

Determining an electronic device's 3D pose, i.e., position and orientation, within an environment can facilitate many applications. For example, localization of a head-mounted device (HMD) within a 3D environment may be used to determine where to display content such that it appears at desired locations relative to other objects within the 3D environment that the user is viewing, e.g., positioning a label augmentation to appear on top of a real object to which it corresponds. Existing techniques for localizing a device may lack efficiency and accuracy, for example, in certain situations. For example, existing system for device localization on moving platforms such as buses, trains, planes, subways, etc., may lack efficiency and accuracy.

### SUMMARY

Various implementations disclosed herein include devices, systems, and methods that localize a device (e.g., determine a device pose) in a 3D environment based on sensor data and semantic segmentation information. Some implementations provide device localization on moving platforms (e.g., trains, buses, cars, etc.) based on camera images (i.e., vision). Since motion (i.e., IMU) data may not be reliable in such moving environments, image and/or other sensor data may be more heavily relied upon than in other circumstances.

Some implementations improve the usability of vision-based tracking, e.g., using tracking features points from vision-based tracking more efficiently and/or effectively. This may involve identifying and removing outlier tracking feature points based on semantics. For example, tracking features points corresponding to the outside environment, which is not moving with the moving platform, may be excluded based on semantic information identifying that they are not part of the moving platform (e.g., that they are instead seen through a window, not trackable, etc.). Such techniques may be particularly useful where the sensor(s) used for tracking and the sensor(s) used for semantics are different. Such techniques may be particularly useful where the semantic and tracking data involves different frame rates. Some implementations involve generating semantic keyframes, e.g., frames of data that identify semantic information from particular viewpoints/keyframe positions within a 3D environment.

Such semantic keyframes may then be used to determine how to treat tracking feature points. In some implementations, tracking feature points may be generated and 3D positions of those tracking feature points identified (e.g., via triangulation or approximation). The 3D positions of such feature points may be projected into an appropriate (e.g., closest to the current viewpoint) semantic keyframe to determine semantic labels for those feature points, i.e., whether each tracking feature point corresponds to a window, is trackable, etc. Such semantics may be used to determine whether the tracking feature points are to be treated as outliers based on their semantics and thus excluded from use in device localization. Using semantics to determine which points to include and exclude from device localization may improve accuracy and/or efficiency of such processes.

Some implementations may be embodied in methods, at a device having a processor and one or more sensors, for example, that execute instructions stored in a computer-readable medium to perform operations. Some methods involve obtaining semantic keyframes corresponding to a physical environment while a device is on a moving platform. The semantic keyframes may each provide a 2D image identifying semantic labels for portions of the physical environment visible from a respective viewpoint within the physical environment. The semantic keyframes may be generated based on images captured by a first set of one or more of the sensors (e.g., image sensors, depth sensors, etc.).

The methods may further involve determining a plurality of tracking features based on data from a second set of the one or more sensors. In some implementations, the second set of sensors differs from the first set of sensors. In some implementations, the semantic keyframes may be generated at a different frame rate than tracking data.

The method may further involve determining semantic labels for the tracking features based on the semantic keyframes. This may involve determining a set of 3D positions of the tracking features, e.g., based on triangulation if there are two or more tracking sensors and/or using a 3D position approximation technique. Projecting the 3D positions into the semantic keyframes may enable determination of semantic labels for those tracking features, for example, by assigning semantic labels to the tracking features based on the semantic segments of the semantic keyframes to which those features are projected.

The method may further involve selecting a subset of the tracking features based on the semantic labels determined for the tracking features. The subset may exclude tracking features (e.g., outliers) that are determined to be associated with an external environment separate from the moving platform based on the semantics.

The method may further involve tracking the pose (e.g., 3D position and orientation) of the device over time in the physical environment using the subset of tracking features (e.g., excluding outliers from such localization).

Some implementations provide device localization based on identifying and removing of outlier tracking feature points based on semantics. Outliers may be rejected based on different semantics in different types of environments, e.g., rejecting window glass feature points on moving platforms and TV/monitor feature points in non-moving environments.

Some such implementations may be embodied in methods, at a device having a processor and one or more sensors, for example, that execute instructions stored in a computer-readable medium to perform operations. Some such methods involve obtaining semantic keyframes corresponding to a physical environment, the semantic keyframes each providing a 2D image identifying semantic labels for portions of the physical environment visible from a respective viewpoint within the physical environment, wherein the semantic keyframes are generated based on images captured by a first set of one or more of the sensors. The methods may involve determining a plurality of tracking features based on data from a second set of the one or more sensors. The methods may involve determining semantic labels for the tracking features based on the semantic keyframes. The methods may involve determining a type of the physical environment and, based on the type of the physical environment, selecting a subset of the tracking features based on the semantic labels determined for the tracking features. The methods may involve tracking the pose of the device in the physical environment using the subset of tracking features.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment in accordance with some implementations.

FIG. 2 illustrates a semantic keyframe depicting a portion of the physical environment of FIG. 1, in accordance with some implementations.

FIG. 3 illustrates a keyframe with masks added based on the semantic keyframe of FIG. 2, in accordance with some implementations.

FIG. 4 illustrates the positions/viewpoints of multiple semantic keyframes captured along a path, in accordance with some implementations.

FIG. 5 illustrates tracking features identified in the physical environment of FIG. 1, in accordance with some implementations.

FIG. 6 illustrates projection of the tracking features of FIG. 5 into the keyframe with masks added of FIG. 3, in accordance with some implementations.

FIG. 7 illustrates triangulation of a tracking feature to a 3D position and projection of that 3D position onto the masked keyframe of FIG. 3, in accordance with some implementations.

FIG. 8 is a flowchart illustrating a method for device localization on a moving platform, in accordance with some implementations.

FIG. 9 is a flowchart illustrating a method for device localization based on environment-specific semantics, in accordance with some implementations.

FIG. 10 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

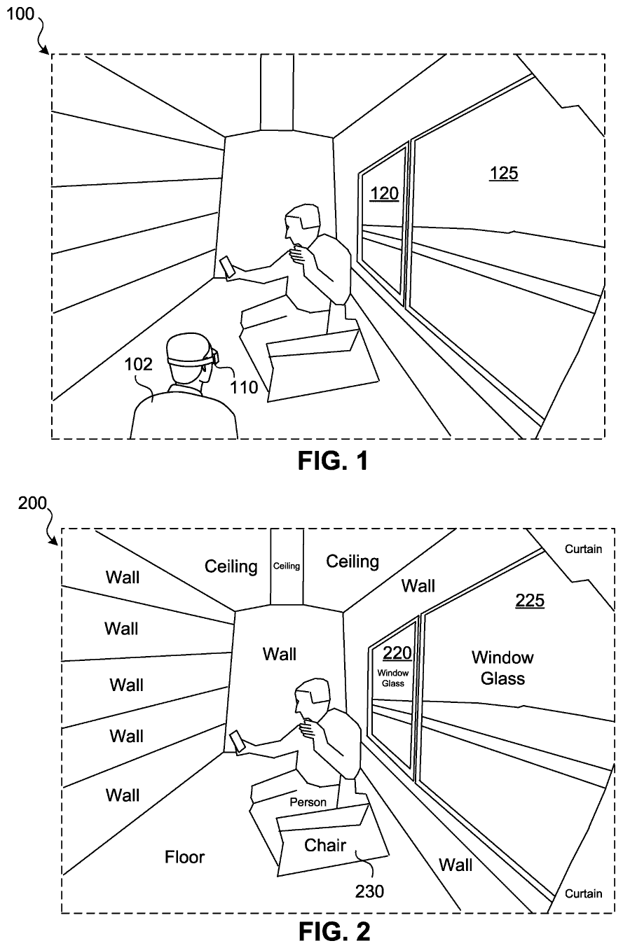

FIG. 1 illustrates an exemplary electronic devices 110 operating in a physical environment 100. In the example of FIG. 1, the physical environment 100 is a train interior, including windows 120, 125.

The electronic device 110 may include one or more cameras, microphones, depth sensors, or other sensors that can be used to capture information about and evaluate the physical environment 100 and the objects within it, as well as information about the user 102 of electronic device 105. The information about the physical environment 100 and/or user 102 may be used to provide visual and audio content and/or localize the device 110 within the physical environment 100.

In some implementations, views of an extended reality (XR) environment may be provided to one or more participants (e.g., user 102 and/or other participants not shown) via electronic device 110 (e.g., a wearable device such as an HMD, a handheld device such as a mobile device, a tablet computing device, a laptop computer, etc.). Such an XR environment may include views of a 3D environment that is generated based on camera images and/or depth camera images of the physical environment 100. Such an XR environment may include a representation of user 102 based on camera images and/or depth camera images of the user 102. Such an XR environment may include virtual content that is positioned at 3D locations relative to a 3D coordinate system (e.g., a 3D space) associated with the XR environment, which may correspond to a 3D coordinate system of the physical environment 100.

In some implementations, video (e.g., pass-through video depicting a physical environment) is received from an image sensor of a device (e.g., device 110) and used to present the XR environment. In other implementations, optical see-through may be used to present the XR environment by overlaying virtual content on a view of the physical environment seen through a translucent or transparent display. In some implementations, a 3D representation of a virtual environment is aligned with a 3D coordinate system of the physical environment. A sizing of the 3D representation of the virtual environment may be generated based on, inter alia, a scale of the physical environment or a positioning of an open space, floor, wall, etc. such that the 3D representation is configured to align with corresponding features of the physical environment. In some implementations, a viewpoint within the 3D coordinate system may be determined based on a position of the electronic device within the physical environment. The viewpoint may be determined based on, inter alia, image data, depth sensor data, motion sensor data, etc., which may be retrieved via a virtual inertial odometry system (VIO), a simultaneous localization and mapping (SLAM) system, etc.

People may sense or interact with a physical environment or world without using an electronic device. Physical features, such as a physical object or surface, may be included within a physical environment. For instance, a physical environment may correspond to a physical city having physical buildings, roads, and vehicles. People may directly sense or interact with a physical environment through various means, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may have direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

In some implementations, the device 110 obtains physiological data (e.g., EEG amplitude/frequency, pupil modulation, eye gaze saccades, etc.) from the user 102 via one or more sensors (e.g., a user facing camera). For example, the device 110 may obtain pupillary data (e.g., eye gaze characteristic data) and may determine a gaze direction of the user 102. While this example and other examples discussed herein illustrates a single device 110 in a real-world physical environment 100, the techniques disclosed herein are applicable to multiple devices and multiple sensors, as well as to other real-world environments/experiences. For example, the functions of the device 110 may be performed by multiple devices.

FIG. 2 illustrates a semantic keyframe 200 depicting a portion of the physical environment of FIG. 1. The semantic keyframe 200 may be associated with a position/viewpoint within a 3D coordinate system corresponding to the physical environment 100 of FIG. 1. The semantic keyframe 200 may be one or more images associated with such a position/viewpoint. The semantic keyframe 200 may be a 2D image with individual pixel values or regions of pixels that are given semantic labels (e.g., wall, ceiling, window, curtain, person, chair, etc.). In the example of FIG. 2, the semantic keyframe includes pixel regions that are assigned semantic labels, e.g., all the pixels in a given region are given one label (e.g., wall), all the pixels in a second region are given a second label (e.g., window glass), etc. As examples, all the pixels in region 220 are given the semantic label “window glass”, all the pixels in region 225 are given the semantic label “window glass”, all the pixels in region 230 are labelled chair, etc.

Various techniques may be used to generate semantic keyframes, such as semantic keyframe 200 of FIG. 2. In some implementations, sensor data associated with a given point in time (e.g., corresponding to a given capture position/viewpoint within the environment) is processed by a semantic process, e.g., an algorithm, machine learning model, etc. For example, one or more images captured at a given point in time may be input to a machine learning model trained to determine semantic labels for the pixels of the image. Such a model may be trained using ground truth labeled semantic images, e.g., images having pixels already labeled with known, correct semantic labels. In one example, such a model inputs a single image (e.g., a single RGB or greyscale image). In another example, such a model inputs multiple images that are captured simultaneously (e.g., two RGB or greyscale images). Such a model may (or may not) utilize prior data (e.g., prior semantic determinations based on prior captures/viewpoints in the same environment). In some implementations, a semantic segmentation process utilizes or includes a material segmentation process, e.g., identifying material types for portions of an environment depicted in one or more images, e.g., glass, wood, drywall, fabric, etc.

In some implementations, output from a semantic labeling process that is utilized for other purposes (e.g., to enhance XR content based on scene understanding) is additionally or alternatively used for device localization.

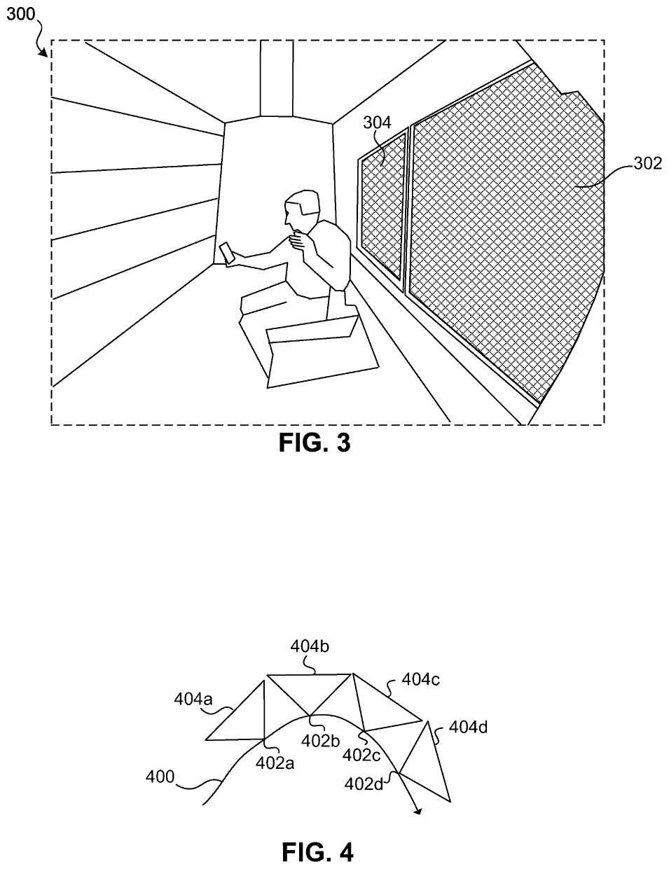

FIG. 3 illustrates a keyframe 300 with masks 302, 304 added based on the semantic keyframe of FIG. 2. In this example, the masks 302, 304 correspond to depictions of portions of an environment for which corresponding sensor data is to be excluded from device localization. In this example, masks 302, 304 correspond to the regions 220, 225 that are semantically labelled “window glass” in the semantic keyframe 200. Other implementations will not involve determining masks and, for example, may instead determine portions of the environment for which corresponding sensor data is to be excluded directly from a semantic keyframe such as semantic keyframe 200 of FIG. 2.

FIG. 4 illustrates the positions/viewpoints of multiple semantic keyframes 404a-d captured along a path 400. In this example, the semantic keyframes 404a-d are generated as the device is moved along path 400 capturing sensor data at various points in time. When the device is at position 402a, sensor data is captured and used to generate semantic keyframe 404a. When the device is at position 402b, sensor data is captured and used to generate semantic keyframe 404b. When the device is at position 402c, sensor data is captured and used to generate semantic keyframe 404c. When the device is at position 402d, sensor data is captured and used to generate semantic keyframe 404d. In some implementations, the device repeatedly captures sensor data for generating semantic frames as the device moves along a path. Multiple semantic frames may be considered and/or generated and only a subset of the semantic frames selected as semantic keyframes, for example, based on keyframe selection criteria. For example, keyframes may be selected to avoid or minimize overlap amongst keyframes and/or to prioritize more recent and/or higher confidence frames. In some implementations, a newly-generated semantic frame may substantially overlap (e.g., more than a threshold percentage of pixels) a prior semantic keyframe (e.g., with respect to which portion of the environment is depicted in the keyframes). The newly-captured semantic frame may replace the prior semantic keyframe in the set of semantic keyframes used for device localization. Such replacement may be based on various criteria, e.g., recency, quality, confidence, etc.

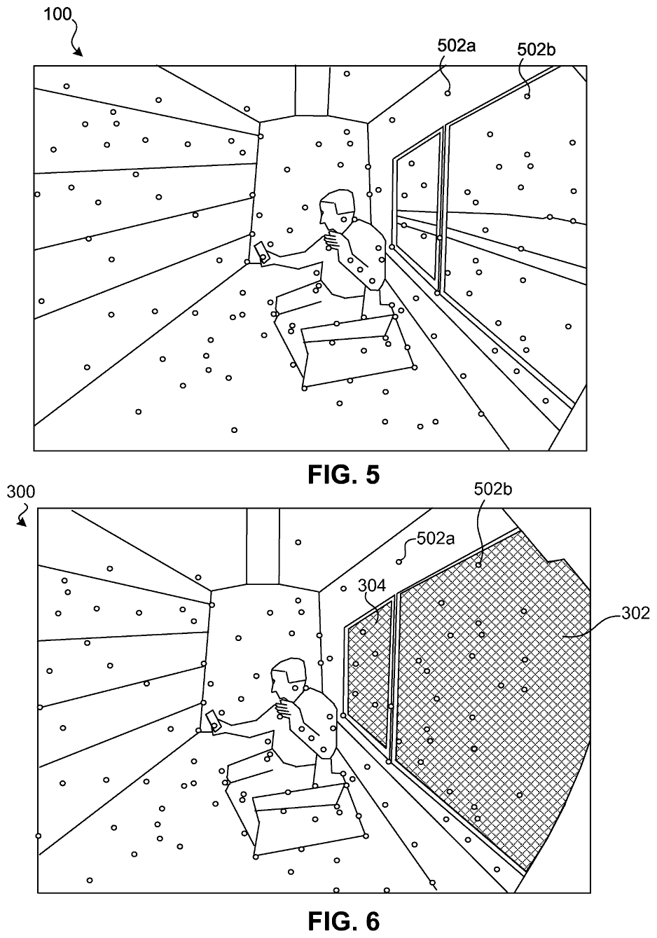

FIG. 5 illustrates tracking features identified based on the physical environment 100 of FIG. 1. Such tracking features may be identified on one or more images of the physical environment 100. Tracking feature identification (e.g., in such images) may involve an algorithm or computer vision model, e.g., using a machine learning model that identifies portions of an image-such as small groups of pixels-corresponding to distinguishable or relatively unique appearances. Tracking features may (but do not necessarily) correspond to edges, corners, and areas where there is variation, pattern, or other relatively unique appearance attributes. In the example of FIG. 5, tracking feature 502a corresponds to an area on a wall on the interior of the moving platform environment of FIG. 1 while tracking feature 502b corresponds to a portion of the exterior environment visible through the window glass 125 of FIG. 1.

FIG. 6 illustrates projection of the tracking features of FIG. 5 into the keyframe 300 with masks added of FIG. 3. The projection of such tracking features may involve determining their respective 3D positions and then projecting those 3D positions into the viewpoint of the corresponding semantic keyframe, e.g., into the closest semantic keyframe to the device's current pose. The tracking feature 502a is projected to a position in the masked keyframe 300 of FIG. 3. This positioning can be used to determine an appropriate semantic label for the tracking feature 502a (e.g., wall, trackable, etc.) and/or whether to include or exclude the tracking feature 502a for device localization. In this example, the tracking feature 502a will be included in the device localization determination.

The tracking feature 502b is projected to a position within mask 302 in the masked keyframe 300 of FIG. 3. This positioning can be used to determine an appropriate semantic label for the tracking feature 502b (e.g., window glass, un-trackable, etc.) and/or whether to include or exclude the tracking feature 502b for device localization. In this example, the tracking feature 502b will be excluded from the device localization determination.

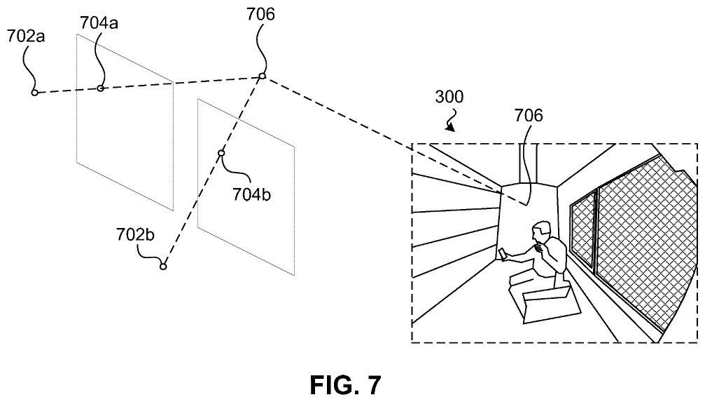

FIG. 7 illustrates triangulation of a tracking feature to a 3D position and projection of that 3D position onto the masked keyframe of FIG. 3. In this example, a tracking feature is identified in two images (e.g., two images simultaneously captured from left and right cameras on an HMD, respectively). Two viewpoints (e.g., left eye viewpoint 702a and right eye viewpoint 702b) are used to triangulate the 3D position 706, e.g., by casting a first ray from the left camera viewpoint 702a through the position 704a in a left camera image, casting a second ray from the right camera viewpoint 702b through the position 704b in a right camera image, and identifying an intersection (or nearest intersecting 3D position) as the 3D position 706 of the tracking feature. This 3D position 706 of the tracking can then be projected into a semantic keyframe to identify its positions 706 therein, e.g., projecting based on the position/viewpoint associated with the semantic keyframe.

Some implementations disclosed herein are well-suited for providing device localization on moving platforms, e.g., trains, subways, airplanes, other vehicles. Electronic devices may utilize different device tracking modes in different circumstances, e.g., applying a travel mode based on detecting the user being on a moving platform or a user manually turning on a moving platform-specific device localization option. On such moving platforms, motion sensor data (e.g., from an IMU on a device) may be unusable/unreliable for localization. In such circumstances, device localization may be largely or entirely based upon other sensors (e.g., vision sensors). However, at least some of the data from such sensors may also be unreliable, e.g., images captured in trains, vehicles, and other moving platforms may depict portions of the outside world that is not moving with the moving platform and thus as the potential to confuse or interfere with a tracking algorithm or other process.

Some implementations utilize semantic segmentations to understand whether sensor data captured by a device corresponds to portions of an environment that are outside the moving platform (e.g., visible through a window) or are portions of the environment that move with the moving platform (e.g., the interior of a vehicle, etc.). Correlating semantic information in some circumstances may require additional processes. For example, on some devices, semantic segmentation may be performed using data from a different sensor (e.g., camera(s)) than the sensor (e.g., camera(s)) that used for device localization and tracking. Similarly, for some devices, semantic segmentation may be run at a different (e.g., much lower) frame rate that device localization and tracking such not every tracking frame is accompanied with simultaneously captured/determined semantic segmentation.

Some implementations facilitate semantic segmentation usage by associating semantic information with capture positions and/or viewing directions. A semantic segmentation image (e.g., a semantic keyframe) may be saved along with its position in 3D space. The device localization and tracking processes can then use these semantic keyframes as needed. For example, whenever the device localization and tracking processes need semantic information (e.g., a semantic label) for a tracking feature, such processes can lookup appropriate semantic information by identifying an appropriate semantic keyframe (e.g., the semantic keyframe have a view most similar to the device's current view), identifying a portion of the semantic keyframe (e.g., by projecting a tracking feature into the semantic keyframe), and using the semantic information associated with that portion. In this way, the device localization and tracking processes may identify semantics for many or all of the tracked features that are used and can selectively use or filter such tracked features accordingly, e.g., identifying inlier tracking features to be used and outlier tracking features to be excluded from use.

In some implementations, device localization and tracking processes maintain a set of semantic keyframes, anchor those keyframes to a map (e.g., to a SLAM map), and update and relace keyframes overtime, e.g., to maximize collective field of view and/or avoid overlap.

Some implementations determine a type of environment, e.g., moving or not moving, in a house, in a building, in an outdoor area, etc., and then perform device localization accordingly. Such information may be used to determine how to use semantic information in filtering tracking features. While in a house, for example, semantic information may be used exclude tracking features corresponding to displays such as TVs, monitors, etc., and, while moving (e.g., on a moving platform), exclude tracking features corresponding to exterior environment visible through windows or glass.

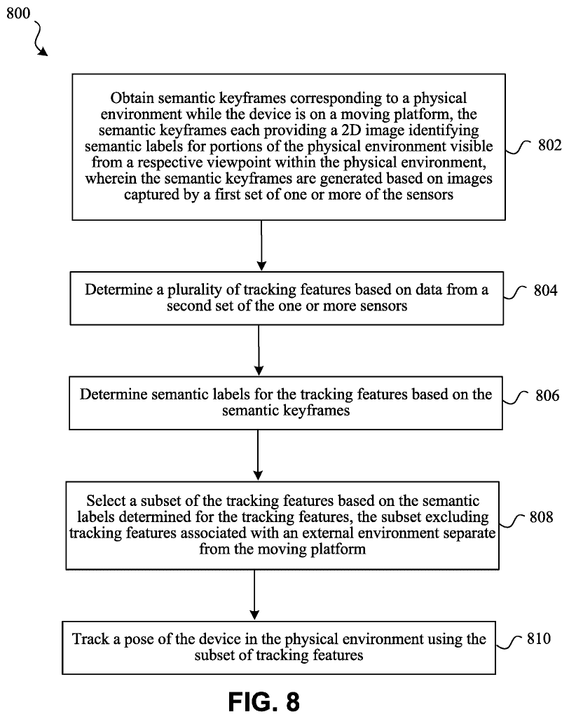

FIG. 8 is a flowchart illustrating a method 800 for device localization on a moving platform. In some implementations, a device such as electronic device 110 performs method 800. In some implementations, method 800 is performed on a mobile device, desktop, laptop, HMD (e.g., device 110), or server device. The method 800 is performed by processing logic, including hardware, firmware, software, or a combination thereof. In some implementations, the method 800 is performed on a processor executing code stored in a non-transitory computer-readable medium (e.g., a memory). In some implementations, the device performing the method 800 includes a processor and one or more sensors.

Various implementations of the method 800 improve world tracking and localization of an electronic device (e.g., device 110) based on vision (e.g., stereo camera images) and/or other sensor data. In various implementations, this involves identifying features in image(s) that correspond to external, non-moving environments to identify and remove outliers associated with such external, non-moving environments. Mistaking external, non-moving environment portions as being part of a device's moving platform environment may reduce tracking and localization accuracy and/or may result in drift of virtual content that is positioned based on that tracking and localization.

At block 802, the method 800 involves obtaining semantic keyframes corresponding to a physical environment while a device is on a moving platform (e.g., bus, train, subway, automobile, etc.), the semantic keyframes each providing a 2D image identifying semantic labels for portions of the physical environment visible from a respective viewpoint within the physical environment, wherein the semantic keyframes are generated based on images captured by a first set of one or more of the sensors.

The semantic keyframes may be generated based on sensor data including, but not limited to, image data (e.g., RGB data), depth data (e.g., lidar-based depth data, and/or densified depth data), device or head pose data, or a combination thereof, for each frame of the sequence of frames. FIGS. 2 and 3 illustrate examples of semantic keyframes and FIG. 4 illustrates an exemplary set of semantic keyframes obtained along a path in an environment.

The semantic labels for the portions of the physical environment may identify whether the portions of the environment correspond to transparent window portions. The semantic labels for the portions of the physical environment may identify which portions of the environment correspond to portions that move with the moving platform and which portions of the environment do not move with the moving platform.

At block 804, the method 800 involves determining a plurality of tracking features based on data from a second set of the one or more sensors. The second set of sensors may differ from (or be the same as) the first set of sensors and/or the semantic keyframes may be generated at a different frame rate than tracking data.

At block 806, the method 800 involves determining semantic labels for the tracking features based on the semantic keyframes. In some implementations, the semantic labels may be determined based on projecting the 3D positions of the tracking features into one or more of the semantic keyframes. This may involve determining a set of 3D positions of the tracking features, e.g., based on triangulation if there are 2 or more tracking cameras or an approximation technique if, for example, only one tracking camera is used, and projecting the 3D positions into the semantic keyframes to determine the semantic labels. Thus, determining the semantic labels for the tracking features may comprises: determining a set of three-dimensional (3D) positions of the tracking features; and determining the semantic labels based on the 3D positions and the semantic keyframes. Determining the 3D positions may comprise triangulating tracking features based on simultaneous images captured by multiple sensors of the second set of one or more sensors. Determining the 3D positions may comprise approximating the 3D positions based on one or more images captured by a single sensor of the second set of one or more sensors.

In some implementations, the semantic labels may be determined based on projecting information (e.g., semantic labels for points, areas, etc.) from the semantic keyframes onto the tracking camera(s) viewpoint. In many circumstances, there will be relatively small translations of the tracking camera relative (e.g., when the user is sitting or standing). In such circumstances (e.g., under the assumption of small translation of the tracking camera relative to the semantic keyframe), regions of the semantic image can be projected onto the tracking camera, for example, via a homography that provides an approximation (e.g., based on an assumption that the scene is sufficiently far relative to the translation of the camera). Alternatively, the system may compute 3D points in the semantic frames in either a sparse or dense manner. In the case of the sparse 3D, the 3D points may be computed similarly to how they are computed in the tracking cameras. These 3D features may then be projected onto the tracking camera and assign labels to any nearby tracking features. In the case of dense 3D, the 3D position of each pixel may be computed (via one of several methods such as dense stereo, depth sensors, neural networks, etc.) and then each pixel may be projected onto the tracking camera viewpoint. This may be computationally expensive, but the process may be configured to advantageously utilize GPU acceleration to improve performance.

The second set of sensors may be different from the first set of sensors. The semantic keyframes may be generated at a different frame rate than the tracking features.

FIG. 7 illustrates an exemplary triangulation and reprojection technique.

At block 808, the method 800 involves selecting a subset of the tracking features based on the semantic labels determined for the tracking features, the subset excluding tracking features associated with an external environment separate from the moving platform.

At block 810, the method 800 involves tracking a pose (i.e., 3D position & orientation) of the device in the physical environment using the subset of tracking features.

In some implementations, the method 800 further includes presenting a view (e.g., one or more frames) of an XR environment on a display, wherein the view of the XR environment includes virtual content and at least a portion of the physical environment.

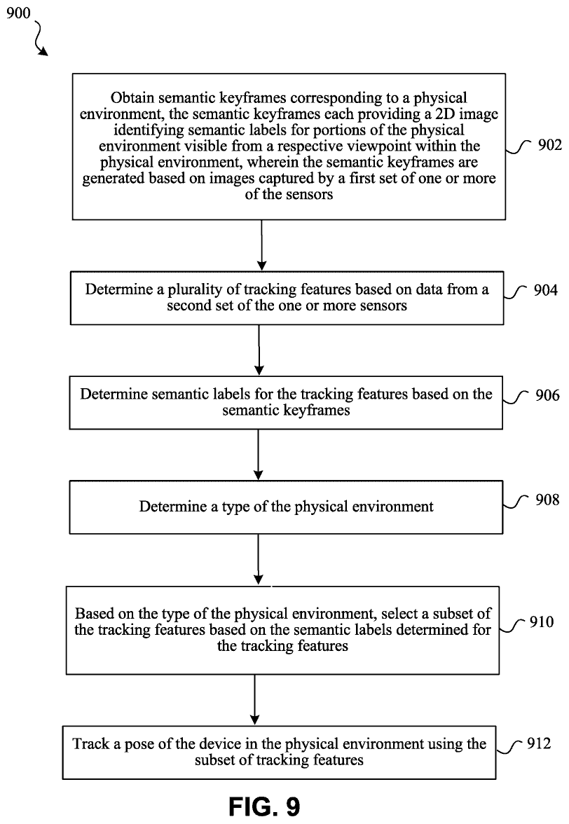

FIG. 9 is a flowchart illustrating a method for device localization based on environment-specific semantics. In some implementations, a device such as electronic device 110 performs method 900. In some implementations, method 900 is performed on a mobile device, desktop, laptop, HMD (e.g., device 110), or server device. The method 900 is performed by processing logic, including hardware, firmware, software, or a combination thereof. In some implementations, the method 900 is performed on a processor executing code stored in a non-transitory computer-readable medium (e.g., a memory). In some implementations, the device performing the method 900 includes a processor and one or more sensors.

At block 902, the method 900 involves obtaining semantic keyframes corresponding to a physical environment, the semantic keyframes each providing a 2D image identifying semantic labels for portions of the physical environment visible from a respective viewpoint within the physical environment, wherein the semantic keyframes are generated based on images captured by a first set of one or more of the sensors.

At block 904, the method 900 involves determining a plurality of tracking features based on data from a second set of the one or more sensors. At block 906, the method 900 involves determining semantic labels for the tracking features based on the semantic keyframes. At block 908, the method 900 involves determining a type of the physical environment. Determining the type of the physical environment may be based on the semantic keyframes and/or the data from the second set of the one or more sensors. At block 910, the method 900 involves, based on the type of the physical environment, selecting a subset of the tracking features based on the semantic labels determined for the tracking features. At block 912, the method 900 involves tracking a pose of the device in the physical environment using the subset of tracking features.

In some implementations, the type of the physical environment is a moving platform and selecting the subset of the tracking features comprises excluding tracking features associated with an external environment separate from the moving platform based on the semantic labels.

In some implementations, the type of the physical environment is non-moving and selecting the subset of the tracking features comprises excluding tracking features associated with one or more displays of one or more devices in the physical environment based on the semantic labels.

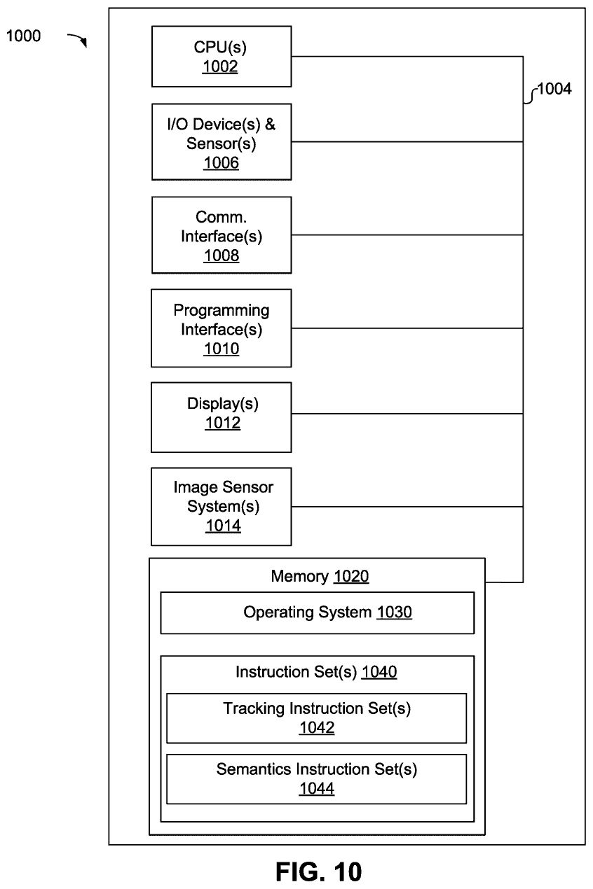

FIG. 10 is a block diagram of electronic device 1000. Device 1000 illustrates an exemplary device configuration for electronic device 110. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1000 includes one or more processing units 1002 (e.g., microprocessors, ASICs, FPGAs, GPUs, CPUs, processing cores, and/or the like), one or more input/output (I/O) devices and sensors 1006, one or more communication interfaces 1008 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 1010, one or more output device(s) 1012, one or more interior and/or exterior facing image sensor systems 1014, a memory 1020, and one or more communication buses 1004 for interconnecting these and various other components.

In some implementations, the one or more communication buses 1004 include circuitry that interconnects and controls communications between system components. In some implementations, the one or more I/O devices and sensors 1006 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 1012 include one or more displays configured to present a view of a 3D environment to the user. In some implementations, the one or more device(s) 1012 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 1000 includes a single display. In another example, the device 1000 includes a display for each eye of the user.

In some implementations, the one or more output device(s) 1012 include one or more audio producing devices. In some implementations, the one or more output device(s) 1012 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 1012 may additionally or alternatively be configured to generate haptics.

In some implementations, the one or more image sensor systems 1014 are configured to obtain image data that corresponds to at least a portion of a physical environment. For example, the one or more image sensor systems 1014 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1014 further include illumination sources that emit light, such as a flash. In various implementations, the one or more image sensor systems 1014 further include an on-camera image signal processor (ISP) configured to execute a plurality of processing operations on the image data.

The memory 1020 includes high-speed random-access memory, such as DRAM, SRAM, DDR RAM, or other random-access solid-state memory devices. In some implementations, the memory 1020 includes non-volatile memory, such as one or more magnetic disk storage devices, optical disk storage devices, flash memory devices, or other non-volatile solid-state storage devices. The memory 1020 optionally includes one or more storage devices remotely located from the one or more processing units 1002. The memory 1020 includes a non-transitory computer readable storage medium.

In some implementations, the memory 1020 or the non-transitory computer readable storage medium of the memory 1020 stores an optional operating system 1030 and one or more instruction set(s) 1040. The operating system 1030 includes procedures for handling various basic system services and for performing hardware dependent tasks. In some implementations, the instruction set(s) 1040 include executable software defined by binary information stored in the form of an electrical charge. In some implementations, the instruction set(s) 1040 are software that is executable by the one or more processing units 1002 to carry out one or more of the techniques described herein.

The instruction set(s) 1040 includes a tracking instruction set 1042 and a semantics instruction set 1044. The instruction set(s) 1040 may be embodied a single software executable or multiple software executables. In some implementations, the content instruction set 1042 is executable by the processing unit(s) 1002 to track and/or otherwise localize a device within a 3D environment as described herein. In some implementations, the semantics instruction set 1044 is executable by the processing unit(s) 1002 to generate and/or associate semantic information with a 3D environment, e.g., by generating and/or update semantic keyframes, as described herein. To these ends, in various implementations, the instruction sets includes instructions and/or logic therefor, and heuristics and metadata therefor.

Although the instruction set(s) 1040 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a device having a processor and one or more sensors:
obtaining semantic keyframes corresponding to a physical environment while the device is on a moving platform, the semantic keyframes each providing a two-dimensional (2D) image identifying semantic labels for portions of the physical environment visible from a respective viewpoint within the physical environment, wherein the semantic keyframes are generated based on images captured by a first set of one or more of the sensors;
determining a plurality of tracking features based on data from a second set of the one or more sensors;
determining semantic labels for the tracking features based on the semantic keyframes;
selecting a subset of the tracking features based on the semantic labels determined for the tracking features, the subset excluding tracking features associated with an external environment separate from the moving platform; and
tracking a pose of the device in the physical environment using the subset of tracking features.

2. The method of claim 1, wherein determining the semantic labels for the tracking features comprises:
determining a set of three-dimensional (3D) positions of the tracking features; and
determining the semantic labels based on the 3D positions and the semantic keyframes.

3. The method of claim 2, wherein determining the 3D positions comprises triangulating tracking features based on simultaneous images captured by multiple sensors of the second set of one or more sensors.

4. The method of claim 2, wherein determining the 3D positions comprises approximating the 3D positions based on one or more images captured by a single sensor of the second set of one or more sensors.

5. The method of claim 2, wherein the semantic labels are determined based on projecting the 3D positions of the tracking features into one or more of the semantic keyframes.

6. The method of claim 1, wherein the second set of sensors is different from the first set of sensors.

7. The method of claim 1, wherein the semantic keyframes are generated at a different frame rate than tracking features.

8. The method of claim 1, wherein the semantic labels for the portions of the physical environment identify whether the portions of the environment correspond to transparent window portions.

9. The method of claim 1, wherein the semantic labels for the portions of the physical environment identify which portions of the environment correspond to portions that move with the moving platform and which portions of the environment do not move with the moving platform.

10. The method of claim 1, wherein the moving platform is a bus, train, or automobile.

11. The method of claim 1, wherein the device is a head mounted device (HMD).

12. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
obtaining semantic keyframes corresponding to a physical environment while the device is on a moving platform, the semantic keyframes each providing a two-dimensional (2D) image identifying semantic labels for portions of the physical environment visible from a respective viewpoint within the physical environment, wherein the semantic keyframes are generated based on images captured by a first set of one or more of the sensors;
determining a plurality of tracking features based on data from a second set of the one or more sensors;
determining semantic labels for the tracking features based on the semantic keyframes;
selecting a subset of the tracking features based on the semantic labels determined for the tracking features, the subset excluding tracking features associated with an external environment separate from the moving platform; and
tracking a pose of the device in the physical environment using the subset of tracking features.

13. The system of claim 12, wherein determining the semantic labels for the tracking features comprises:
determining a set of three-dimensional (3D) positions of the tracking features; and
determining the semantic labels based on the 3D positions and the semantic keyframes.

14. The system of claim 13, wherein determining the 3D positions comprises triangulating tracking features based on simultaneous images captured by multiple sensors of the second set of one or more sensors.

15. The system of claim 13, wherein determining the 3D positions comprises approximating the 3D positions based on one or more images captured by a single sensor of the second set of one or more sensors.

16. The system of claim 13, wherein the semantic labels are determined based on projecting the 3D positions of the tracking features into one or more of the semantic keyframes.

17. The system of claim 12, wherein the second set of sensors is different from the first set of sensors.

18. The system of claim 12, wherein the semantic keyframes are generated at a different frame rate than tracking features.

19. The system of claim 12, wherein the semantic labels for the portions of the physical environment identify whether the portions of the environment correspond to transparent window portions.

20. A non-transitory computer-readable storage medium, storing program instructions executable via a processor to perform operations comprising:
obtaining semantic keyframes corresponding to a physical environment while the device is on a moving platform, the semantic keyframes each providing a two-dimensional (2D) image identifying semantic labels for portions of the physical environment visible from a respective viewpoint within the physical environment, wherein the semantic keyframes are generated based on images captured by a first set of one or more sensors;
determining a plurality of tracking features based on data from a second set of one or more sensors;
determining semantic labels for the tracking features based on the semantic keyframes;
selecting a subset of the tracking features based on the semantic labels determined for the tracking features, the subset excluding tracking features associated with an external environment separate from the moving platform; and
tracking a pose of the device in the physical environment using the subset of tracking features.
